(19) United States
(12) Patent Application Publication
(10) Pub. No.: US 2019/0021143 A1
(43) Pub. Date: Jan. 17, 2019

(54) A MICROWAVE OVEN WITH DRYING FUNCTION

(71) Applicant: ARCELIK ANONIM SIRKETI, Istanbul (TR)

(72) Inventors: Sezgi YIKILMAZCINAR, Istanbul (TR); Metin GUR, Istanbul (TR); Merve GUVEN, Istanbul (TR); Serdal ELMAS, Istanbul (TR); Haluk KARATAS, Istanbul (TR)

(21) Appl. No.: 16/066,027

(22) PCT Filed: Nov. 30, 2016
(86) PCT No.: PCT/EP2016/079254

§ 371 Date: Jun. 25, 2018

(30) Foreign Application Priority Data
Dec. 29, 2015 (TR) A 2015/17189

(51) Int. Cl. H05B 6/64; H05B 6/80; A23L 3/54; A23B 7/02

(52) U.S. Cl. CPC H05B 6/6408; H05B 6/80; H05B 2206/046; A23B 7/02; H05B 6/6491; A23L 3/54

(57) ABSTRACT

Embodiments provide a microwave oven comprising a microwave generator, a control unit that controls the microwave generator, a tray produced from a microwave permeable material and whereon foodstuffs such as vegetables and fruits to be dried are placed, and a cavity wherein the tray is placed.

The present invention relates to a microwave oven wherein especially foodstuffs such as fruits and vegetables are dried.

In order to dry various foodstuffs, especially vegetables and fruits, in a microwave oven, specially formed drying trays are used. In the microwave ovens, the density of the electromagnetic field acting on the central part of the drying tray is higher than the edges of the tray. The foodstuffs placed in the center of the drying tray where the microwave density is higher dry quicker, while a longer period is needed on the edges and corners where the microwave density is lower. When drying of the foodstuffs placed on the edges and corners is completed, the foodstuffs in the center are observed to have burnt.

In the state of the art Great Britain Patent Application No. GB2236646, a microwave oven comprising a tray whereon kitchen utensils are placed and dried is disclosed.

The aim of the present invention is the realization of a microwave oven wherein the foodstuffs are enabled to be homogenously dried.

The microwave oven realized in order to attain the aim of the present invention, explicated in the first claim and the respective claims thereof, comprises a tray (drying tray) produced from a microwave permeable material, and one or more than one conductive plate that is produced from a metal material and that is placed on the corner-edge regions at the base of the tray where the density of the electromagnetic energy is low.

In various embodiments of the present invention, the conductive plates are placed as multiple pieces or a single piece so as to correspond to the edges and corners under the tray, providing that the density of the electromagnetic energy at the center of the tray is reduced and that the microwaves are guided toward the edges and the corners, and thus the foods are homogeneously dried on each region of the drying tray.

The microwave oven realized in order to attain the aim of the present invention is illustrated in the attached figures, where:

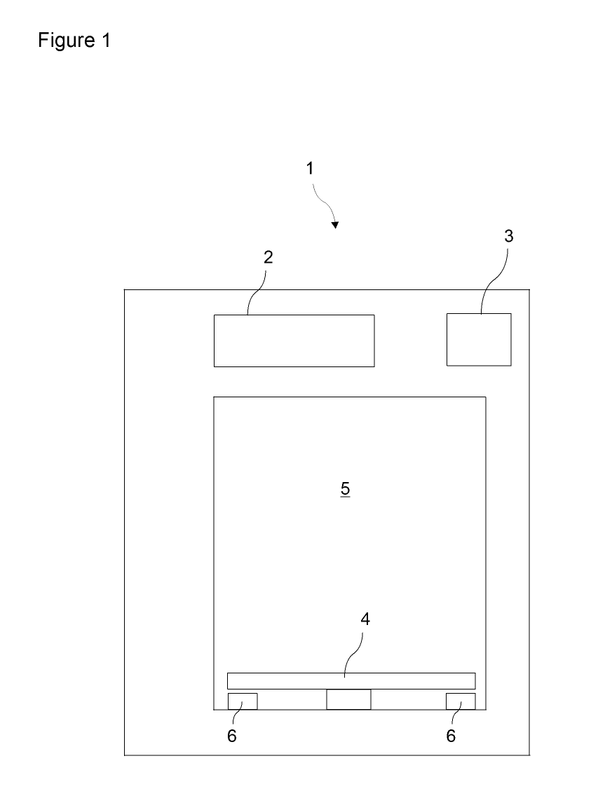

FIG. 1—is the schematic view of a microwave oven.

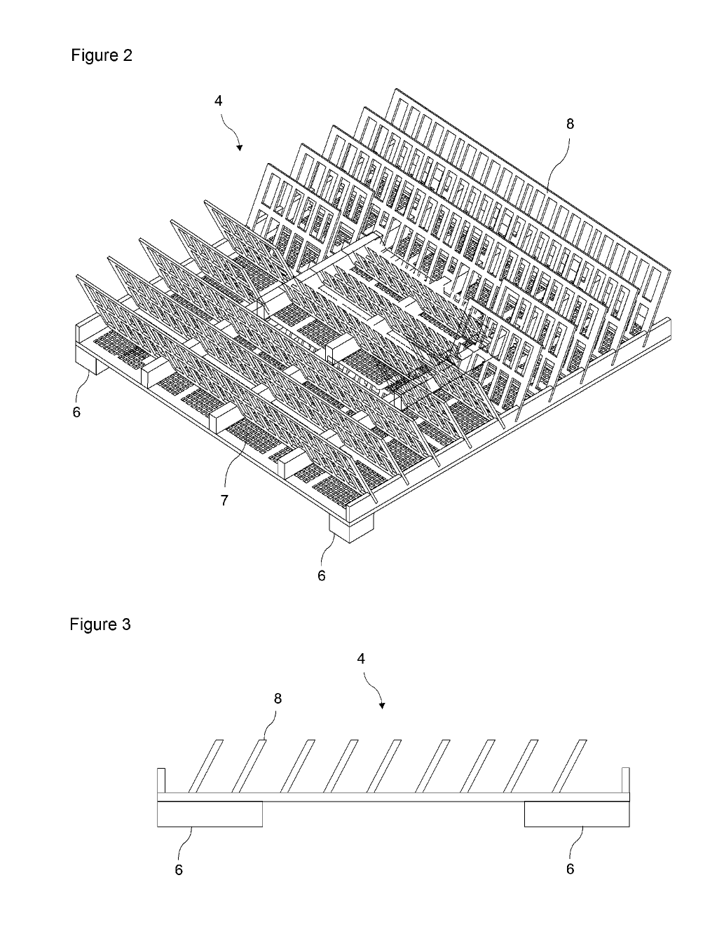

FIG. 2—is the perspective view of a tray used in the drying process.

FIG. 3—is the schematic view of the tray together with the conductive plates placed under the tray.

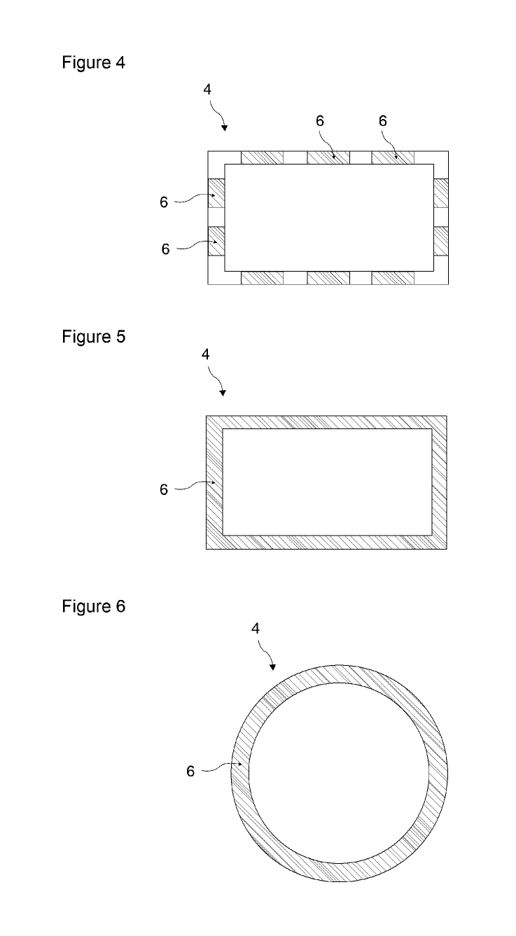

FIG. 4—is the schematic view of a quadrangular tray and of the conductive plates placed at intervals on the edges thereof.

FIG. 5—is the schematic view of a quadrangular tray and of the conductive plate placed as a single piece on the edges thereof.

FIG. 6—is the schematic view of a circular tray and the conductive plate placed as a single piece on the edge thereof.

The elements illustrated in the figures are numbered as follows:

1. Microwave oven

2. Microwave generator

3. Control unit

4. Tray

5. Cavity

6. Conductive plate

7. Hole

8. Support

The microwave oven (1) comprises a microwave generator (2), a control unit (3) that controls the microwave generator (2), a tray (4) produced from a microwave permeable material and whereon foodstuffs such as vegetables and fruits to be dried are placed, and a cavity (5) wherein the tray (4) is placed.

The microwave oven (1) of the present invention comprises one or more than one conductive plate (6) that is produced from a metal material, that is placed at the underside of the tray (4) in the edge and/or corner regions of the tray (4) wherein the density of the electromagnetic energy is low and that enables the microwaves to be directed to the said edge and/or corner regions of the tray (4).

After the foodstuffs, especially vegetables and fruits, to be dried are placed on the tray (4), the tray (4) is placed into the microwave oven (1). The microwave generator (2) operated by the control unit (3) provides the dissipation of the electromagnetic energy inside of the microwave oven (1). The conductive plates (6) produced from a metal material function as a lightning conductor and the electromagnetic energy is drawn toward the metal conductive plates (6) disposed on the corners and/or edges of the tray (4). The microwaves are enabled to be directed from the central parts of the tray (4) where the density of the electromagnetic energy is high toward the edge and/or corner parts where the density of the electromagnetic energy is lesser. Thus, the foodstuffs placed into the tray (4) are enabled to be homogenously dried within a short period. Moreover, since part of the microwaves acting on the central parts of the tray (4) is directed to the edges and/or corners, the density of the electromagnetic energy at the central parts is reduced and the foodstuffs at the said central parts are prevented from burning.

The tray (4) furthermore comprises holes in such size to permit passage of the electromagnetic energy and one or more than one support (8) that enables the foodstuffs to be kept in an orderly manner.

In an embodiment of the present invention, the conductive plates (6) are fixed at the underside of the tray (4), on the edge and/or corner sections where the electromagnetic energy is low (FIG. 2).

In another embodiment of the present invention, the conductive plates (6) are fixed on the base of the cavity (5) so as to correspond to the underside of the tray (4), to the edge and/or corner sections where the electromagnetic energy is low (FIG. 1).

In an embodiment of the present invention, the conductive plates (6) are placed at intervals—preferably at equal intervals—on the edges of the tray (4). Thus, the density of the electromagnetic energy which is high at the central part is directed by means of the conductive plates (6) toward the edges and a homogenous electromagnetic energy density is obtained on the tray (4) (FIG. 4).

In another embodiment of the present invention, the conductive plate (6) extends along the edges of the tray (4). In this embodiment, the microwave oven (1) comprises for example a single-piece conductive plate (6) produced from a metal material in the form of a quadrangular frame that extends all along the edges of a quadrangular tray (4) (FIG. 6) or a single-piece conductive plate (6) produced from a metal material in the form of a ring that extends all along the periphery of the circular tray (4) (FIG. 6).

In another embodiment of the present invention, the tray (4) has a quadrangular form, and the conductive plates (6) are placed on at least one corner of the tray (4) (FIG. 2).

The conductive plates (6) of the present invention direct the electromagnetic energy with high density that acts on the central part of the tray (4) in the microwave oven (1) to the edge and/or corner parts of the tray (4) that the microwaves affect more weakly, thus providing a homogenous drying process.

1. A microwave oven comprising a microwave generator, a control unit that controls the microwave generator, a tray produced from a microwave permeable material and whereon foodstuffs to be dried are placed, and a cavity wherein the tray is placed, characterized by one or more than one conductive plate that is produced from a metal material, that is placed at the underside of the tray in the edge and/or corner regions of the tray wherein the density of the electromagnetic energy is low and that enables the microwaves to be directed to the said edge and/or corner regions of the tray.

2. The microwave oven as in claim 1, characterized by the conductive plates that are fixed at the underside of the tray, on the edge and/or corner sections thereof.

3. The microwave oven as in claim 1, characterized by the conductive plates that are fixed at the base of the cavity so as to correspond to the edge and/or corner sections of the tray at the underside of the tray.

4. The microwave oven as in claim 1, characterized by the tray comprising holes in such size to permit passage of electromagnetic energy and one or more than one support that enables the foodstuffs to be kept in an orderly manner.

5. The microwave oven as in claim 1, characterized by the conductive plates placed at intervals on the edges of the tray.

6. The microwave oven as in claim 1, characterized by the conductive plate that extends along the edges of the tray.

7. The microwave oven as in claim 6, characterized by a conductive plate that is produced from a single-piece metal material in the form of a quadrangular frame that extends all along the edges of a quadrangular tray.

8. The microwave oven as in claim 1, characterized by the conductive plate placed on at least one corner of a quadrangular tray.

9. The microwave oven as in claim 6, characterized by a conductive plate that is produced from a single-piece metal material in the form of a ring that extends all along the periphery of a circular tray.
